(19) United States
(12) Patent Application Publication
(10) Pub. No.: US 2008/0238886 A1
(43) Pub. Date: Oct. 2, 2008

(54) METHOD FOR PROVIDING TACTILE FEEDBACK FOR TOUCH-BASED INPUT DEVICE

(75) Inventors: Henrik BENGTSSON, Lund (SE); Per HOLMBERG, Dalby (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/861,585

(22) Filed: Sep. 26, 2007

Related U.S. Application Data
(60) Provisional application No. 60/908,907, filed on Mar. 29, 2007.

(51) Int. Cl. G06F 3/041

(52) U.S. Cl. 345/177

(57) ABSTRACT

A system detects when a user's finger is near a key on a touch screen. When the user's finger is near the key, the touch screen may begin to vibrate. The vibrations may increase in frequency and/or intensity as the user's finger approaches the key. The vibrations may decrease in frequency and/or intensity as the user's finger moves away from the key.

### RELATED APPLICATION

This application claims priority under 35 U.S.C. § 119 based on U.S. Provisional Application Ser. No. 60/908,907, filed Mar. 29, 2007, the disclosure of which is incorporated herein by reference.

### BACKGROUND

When using a phone with a keypad, a user may dial a number without looking at the phone. In this situation, the user may feel the keys to determine which key to press. For example, if a user wants to press the 5 key, the user knows it is in the center of the keypad and can feel the surrounding keys to determine which key is the 5 key. The user may then determine the identity of the other keys based on knowing which key is the 5 key. In this manner, the user may, for example, dial a phone number without looking at the keypad.

If a user is using a device with a touch sensitive display, the user will not be able to physically feel the keys. Therefore, it may be more difficult to identify the keys on the display without looking at the display.

### SUMMARY

According to one aspect, a method may include detecting movement of a finger on a touch screen display of a device, and vibrating the device to indicate proximity of the finger to a plurality of objects displayed on the touch screen display.

Additionally, the method may include generating increasing vibrations when the finger approaches one of a plurality of objects on the touch screen, and generating decreasing vibrations when the finger moves away from the one of the plurality of objects on the touch screen.

Additionally, generating increasing vibrations may include generating vibrations with increasing intensity and generating decreasing vibrations may include generating vibrations with decreasing intensity.

Additionally, generating increasing vibrations may include generating vibrations with increasing frequency and generating decreasing vibrations may include generating vibrations with decreasing frequency.

Additionally, the method may include generating maximum vibration when the finger is on top of the one of the plurality of objects or in a zone around the top of one of the plurality of objects.

Additionally, the method may include generating minimum vibration when the finger is equidistant or near equidistant from two adjacent objects.

Additionally, generating minimum vibration may include generating no vibration.

Additionally, the method may include generating an audible signal that increases in volume or frequency when the finger approaches one of the plurality of objects on the touch screen, and generating an audible signal that decreases in volume or frequency when the finger moves away from the one of the plurality of objects on the touch screen.

Additionally, the audible signal may be at maximum volume or frequency when the finger is on top of one of the plurality of objects on the touch screen.

Additionally, the audible signal may be at a minimum volume or frequency when the finger is equidistant from two adjacent objects.

Additionally, the method may include generating an visual signal that increases in brightness or frequency when the finger approaches one of the plurality of objects on the touch screen, and generating an visual signal that decreases in brightness or frequency when the finger moves away from the one of the plurality of objects on the touch screen.

Additionally, the visual signal may be at maximum brightness or frequency when the finger is on top of one of the plurality of objects on the touch screen.

Additionally, the visual signal may be at a minimum brightness or frequency when the finger is equidistant from two adjacent objects.

In another embodiment, a device may include a touch screen display, a vibrator, and processing logic configured to determine a location of a finger of a user on the touch screen display, and cause the vibrator to generate vibrations to indicate proximity of the finger to one of a plurality of objects displayed on the touch screen display.

Additionally, the processing logic may further be configured to cause the vibrator to increase vibrations as the finger approaches one of the plurality of objects, and cause the vibrator to decrease vibrations as the finger moves away from one of the plurality of objects on the touch screen.

Additionally, the processing logic may further be configured to cause the vibrator to vibrate at a maximum level when the finger is on top of one of the plurality of objects or in a zone around the top of one of the plurality of objects.

Additionally, the processing logic may further be configured to cause the vibrator to vibrate at a minimum level when the finger is equidistant or near equidistant from two adjacent objects.

Additionally, the processing logic may further be configured to cause the vibrator to increase the intensity of the vibrations as the finger approaches one of the plurality of objects, and cause the vibrator to decrease the intensity of the vibrations as the finger moves away from one of the plurality of objects.

Additionally, the processing logic may further be configured to cause the vibrator to increase the frequency of the vibrations as the finger approaches one of the plurality of objects, and cause the vibrator to decrease the frequency of the vibrations as the finger moves away from one of the plurality of objects.

Additionally, the device may include a speaker, wherein the speaker may emit a signal when the finger is near one of the plurality of objects.

Additionally, the signal may increase in volume or frequency as the finger approaches one of the plurality of objects and may decrease in volume or frequency as the finger moves away from one of the plurality of objects.

Additionally, the signal may be at maximum volume or frequency when the finger is on top of one of the plurality of objects or near the top of one of the plurality of objects.

Additionally, the signal may be at a minimum volume or frequency when the finger is equidistant or near equidistant from two adjacent objects.

Additionally, a method may include displaying a plurality of graphical objects on a touch screen display of a mobile communication terminal, detecting a position of a finger on the touch screen display, and generating a feedback response for a user of the mobile communication terminal based on the detected position of the finger.

Additionally, the graphical objects may include number keys.

Additionally, the feedback response may include vibration of the mobile communication terminal.

### BRIEF DESCRIPTION OF THE DRAWINGS

Reference is made to the attached drawings, wherein elements having the same reference number designation may represent like elements throughout.

FIG. 1 is a diagram of an exemplary mobile terminal in which methods and systems described herein may be implemented;

FIG. 2 is a diagram illustrating components of the mobile terminal of FIG. 1 according to an exemplary implementation;

FIG. 3 is a diagram depicting an example of the vibrating feedback;

FIG. 4 is a flow diagram illustrating exemplary processing by the mobile terminal of FIG. 1; and

FIG. 5 is a flow diagram illustrating an example of the exemplary processing of FIG. 4.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

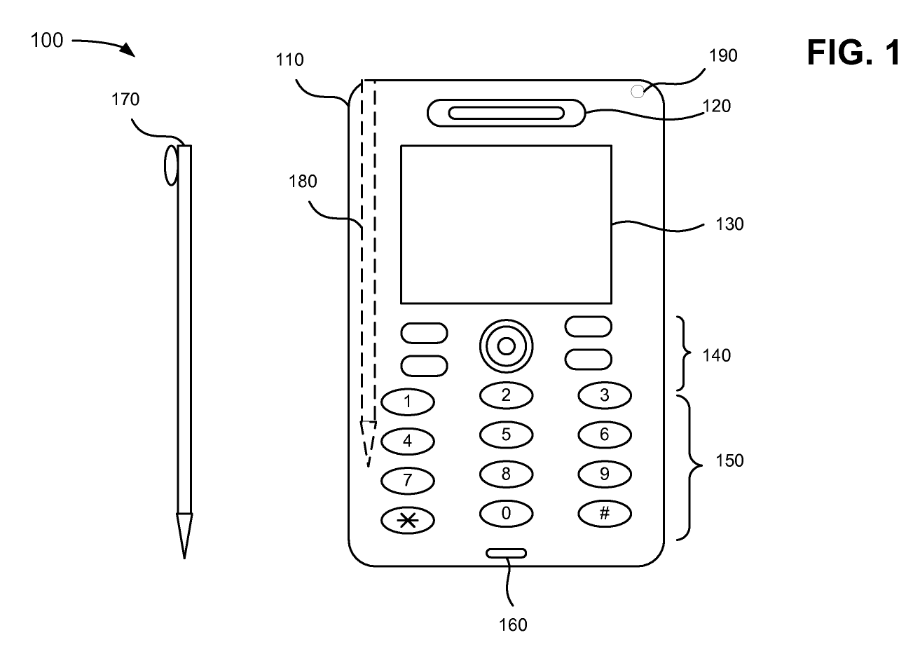

FIG. 1 is a diagram of an exemplary mobile terminal 100 in which methods and systems described herein may be implemented. The invention is described herein in the context of a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. Mobile terminal 100 may also include media playing capability. It should also be understood that systems and methods described herein may also be implemented in other devices that include displays and media playing capability without including various other communication functionality.

Referring to FIG. 1, mobile terminal 100 may include a housing 110, a speaker 120, a display 130, control buttons 140, a keypad 150, a microphone 160, a stylus 170, a slot 180, and an LED 190. Housing 110 may include any structure to support the components of mobile terminal 100. Speaker 120 may include any mechanism(s)/device(s) to provide audible information to a user of mobile terminal 100.

Display 130 may include any device that provides visual information to the user. For example, display 130 may provide information regarding incoming or outgoing calls, games, phone books, the current time, etc. Display 130 may include a liquid crystal display (LCD) or some other type of display that displays graphical information to a user while mobile terminal 100 is operating. The LCD may be backlit using, for example, a number of light emitting diodes (LEDs).

In an exemplary implementation, as described in detail below, display 130 may also include additional elements/components that allow a user to interact with mobile terminal 100 to cause mobile terminal 100 to perform one or more operations, such as place a telephone call, play various media, etc. In one implementation, display 130 may function as a user input interface, such as a touch-screen or panel enabled display. For example, display 130 may include a pressure-sensitive (e.g., resistive), electrically-sensitive (e.g., capacitive), acoustically-sensitive (e.g., surface acoustic wave), photo-sensitive (e.g., infra-red), and/or any other type of display overlay that allows the display to be used as an input device.

Control buttons 140 may include any function keys that permit the user to interact with mobile terminal 100 to cause mobile terminal 100 to perform one or more operations, such as place a telephone call, play various media, etc. For example, control buttons 140 may include a dial button, hang up button, play button, etc. Control buttons 140 may also include a key-lock button that permits the user to activate/deactivate various input mechanisms, such as display 130, control buttons 140, keypad 150, and microphone 160, as described in more detail below. Keypad 150 may include a standard telephone keypad, for example, and/or additional function keys. Microphone 160 may receive audible information from the user, for example, to activate commands. LED 190 may blink to signify events, such as an incoming phone call or a user's finger being on top of a key.

Stylus 170 may include an accessory instrument that may be used to manipulate display 130, control buttons 140, and/or keypad 150, for example, to enter data. In one implementation, stylus 170 may be a pointer or an inkless pen that may be used to “write” information onto or select information from graphics presented on display 130. The type of stylus 170 used may depend upon the type of touch-screen used for display 130. For example, where display 130 includes a pressure-sensitive surface, stylus 170 may include an elongated shaft with a pointed end for contacting the surface of display 130. Additionally, where display 130 includes an electrically-sensitive surface, an acoustically-sensitive surface, or a photo-sensitive surface, stylus 170 may include an end that emits a charge, sound, or light, respectively, that may be directed to the surface of display 130. Stylus 170 may include one or more surface features and/or be contoured to facilitate grasping and/or handling by a user.

Slot 180 may include any component to retain stylus 170 such that a user may retrieve stylus 170 from slot 180 for use with mobile terminal 100. In one implementation, slot 180 may be disposed within housing 110, for example, integrally formed therein and having a shape and/or size sufficient to receive at least a portion of stylus 170. In another implementation, slot 180 may be located externally to housing 110, for example, using retaining components on a surface of housing 110. In another implementation, stylus 170 may be stowed separately from housing 110, for example, attached to housing 110 by a tether.

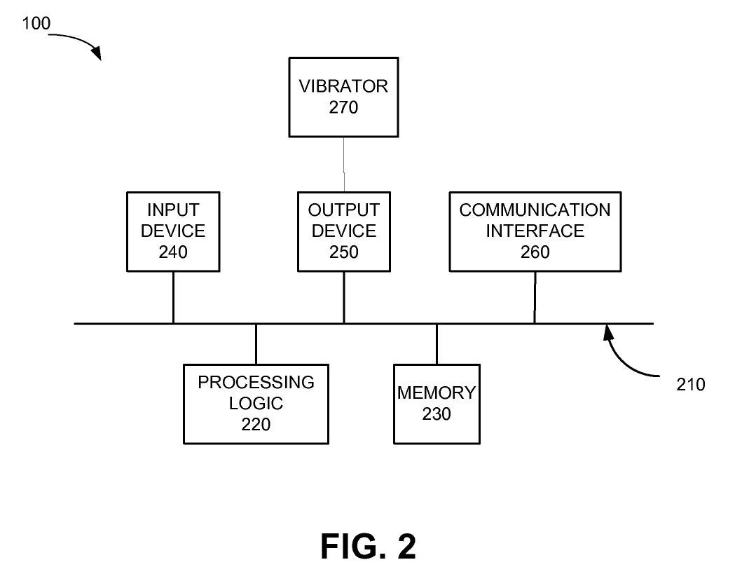

FIG. 2 is a diagram illustrating components of mobile terminal 100 according to an exemplary implementation. Mobile terminal 100 may include processing logic 220, memory 230, input device 240, output device 250, communication interface 260, and a bus 210 that permits communication among the components of mobile terminal 100. One skilled in the art would recognize that mobile terminal 100 may be configured in a number of other ways and may include other or different elements. For example, mobile terminal 100 may include one or more power supplies (not shown). Mobile terminal 100 may also include one or more modulators, demodulators, encoders, decoders, etc., for processing data.

Processing logic 220 may include a processor, microprocessor, an application specific integrated circuit (ASIC), field programmable gate array (FPGA) or the like. Processing logic 220 may execute software instructions/programs or data structures to control operation of mobile terminal 100.

Memory 230 may include a random access memory (RAM) or another type of dynamic storage device that stores information and instructions for execution by processing logic 220; a read only memory (ROM) or another type of static storage device that stores static information and instructions for use by processing logic 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processing logic 220. Instructions used by processing logic 220 may also, or alternatively, be stored in another type of computer-readable medium accessible by processing logic 220. A computer-readable medium may include one or more memory devices and/or carrier waves.

Input device 240 may include mechanisms that permit an operator to input information to mobile terminal 100, such as stylus 170, microphone 160, keypad 150, control buttons 140, display 130, a keyboard, a mouse, a pen, voice recognition and/or biometric mechanisms, etc.

Output device 250 may include one or more mechanisms that output information to the user, including a display, such as display 130, a printer, one or more wired or wireless speakers, such as speaker 120, LED 190, etc.

Output device 250 may further include vibrator 270. Vibrator 270 may vibrate to indicate an incoming call or message or to provide a tactile feedback to the user when the user's finger is near a key on display 130.

Communication interface 260 may include any transceiver-like mechanism that enables mobile terminal 100 to communicate with other devices and/or systems. For example, communication interface 260 may include a modem or an Ethernet interface to a LAN. Communication interface 260 may also include mechanisms for communicating via a network, such as a wireless network. For example, communication interface 260 may include one or more radio frequency (RF) transmitters, receivers and/or transceivers. Communication interface 260 may also include one or more antennas for transmitting and receiving RF data.

Mobile terminal 100 may provide a platform for a user to place and/or receive telephone calls, access the Internet, play various media, such as music files, video files, multi-media files, games, etc. Mobile terminal 100 may perform these operations in response to processing logic 220 executing sequences of instructions contained in a computer-readable medium, such as memory 230. Such instructions may be read into memory 230 from another computer-readable medium via, for example, communication interface 260. A computer-readable medium may include one or more memory devices and/or carrier waves. In alternative embodiments, hard-wired circuitry may be used in place of or in combination with software instructions to implement processes consistent with the invention. Thus, implementations described herein are not limited to any specific combination of hardware circuitry and software.

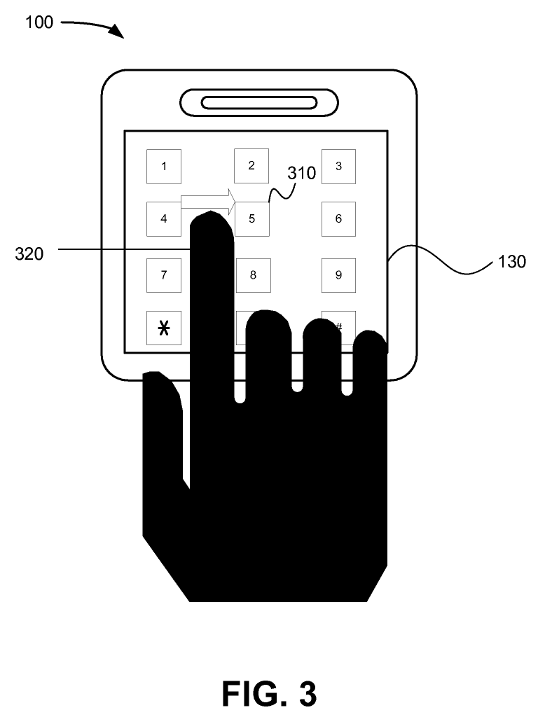

FIG. 3 is a diagram illustrating display 130 of mobile terminal 100 in which graphical objects are shown that may be selected, via touch, by a user. As depicted in FIG. 3, a user may select graphical objects, such as number keys 310 or letter keys, by touching keys 310 with finger 320. Display 130 may be a touch-screen. Keys 310 may be virtual keys that are displayed on display 130. Keys 310 may be selected using finger 320 or stylus 170.

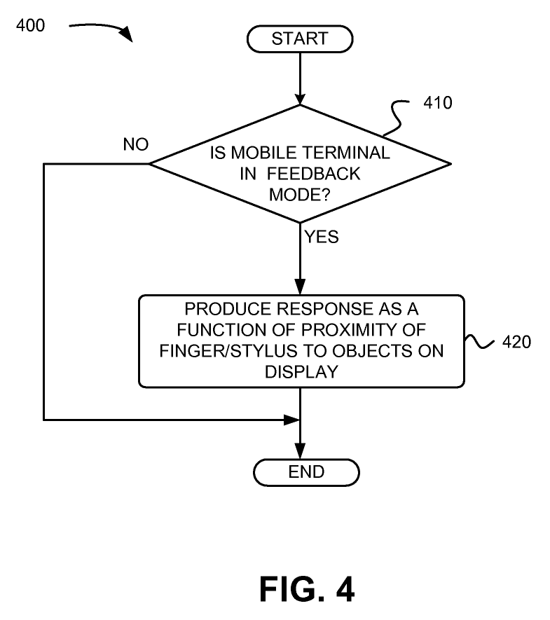

FIG. 4 is a flowchart of exemplary processes according to implementations described herein. The process of FIG. 4 may generally be described as generation of a feedback response when a user runs a finger across a touch sensitive display. As shown in FIG. 4, process 400 may begin by determining whether mobile terminal 100 is in feedback mode (block 410). If it is determined that mobile terminal 100 is in feedback mode (block 410—YES), mobile terminal 100 may provide a response as a function of the proximity of finger 320 or stylus 170 to objects, such as keys 310, on display 130 (block 420). In one implementation, the response may include vibration of the mobile terminal 100. In another implementation, the response may include blinking lights, such as LED 190, on the mobile terminal 100. In another implementation, the response may include a combination of vibration of the mobile terminal 100 and blinking lights on the mobile terminal 100. If it is determined that mobile terminal 100 is not in feedback mode (block 410—NO), process 400 may end.

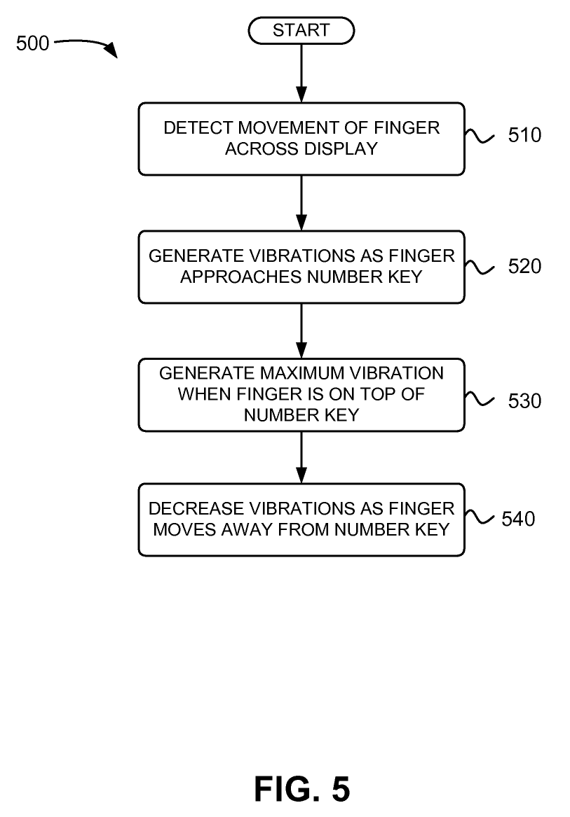

FIG. 5 is a flowchart illustrating operations consistent with one exemplary implementation of block 420. As shown in FIG. 5, process 500 may begin as a user moves finger 320 across display 130 (block 510). Alternatively, instead of using a finger to input information through display 130, the user may move stylus 170 across display 130. The user may move finger 320 in any arbitrary direction over display 130.

As finger 320 approaches key 310, display 130 or mobile terminal 100 may begin to vibrate (block 520). As finger 320 gets closer to key 310, the intensity and/or frequency of the vibrations may increase.

In addition to or in the alternative to a vibratory tactile response, other feedback responses may be exhibited by mobile terminal 100. For example, speaker 120 may emit a sound (for example, beeping) to inform the user that finger 320 is approaching key 310. The volume and/or frequency of the sound may increase as finger 320 gets closer to key 310.

When finger 320 is on top of key 310 or in a zone on top of key 310, display 130 or mobile terminal 100 may generate maximum vibration (block 530). In one embodiment, when finger 320 is on top of key 310, speaker 120 may emit maximum sound.

As finger 320 moves away from key 310, the intensity and/or frequency of the vibrations may begin to decrease (block 540). When finger 320 is equidistant or near equidistant from two adjacent keys 310, display 130 or mobile terminal 100 may generate minimum vibration. Minimum vibration may be zero vibration. In one embodiment, when finger 320 is equidistant from two adjacent keys 310, speaker 120 may emit minimum sound, which may be no sound.

In some implementations, the concepts discussed above may be implemented on tactile keyboards. For example, mobile terminal 100 may vibrate when finger 320 is near a key on keypad 150 or near a control button 140. In this embodiment, mobile terminal 100 may reach a maximum vibration level when finger 320 is on top of a key on keypad 150 or on top of a control button 140. Furthermore, mobile terminal 100 may reach minimum vibration, which may be no vibration, when finger 320 is equidistant from keys on keypad 150 or control buttons 140.

In some implementations, the concepts discussed above may be implemented using blinking LEDs. For example, LED 190 may blink when finger 320 is near a key on keypad 150 or near a control button 140. In this embodiment, LED 190 may reach a maximum frequency of blinking or a maximum brightness when finger 320 is on top of a key or in a zone on top of the key on keypad 150. Furthermore, the frequency of blinking or the brightness of LED 190 may reach a minimum level, which may be no blinking, when finger 320 is equidistant or near equidistant from keys on keypad 150 or control buttons 140.

As described above, a device with a touch-sensitive display may generate a tactile feedback response to a user interacting with the touch-sensitive display. Advantageously, this may allow the user to user the touch-sensitive display without necessarily having to look at the display.

The foregoing description provides illustration and description, but is not intended to be exhaustive or to limit the invention to the precise form disclosed. Modifications and variations are possible in light of the above teachings or may be acquired from practice of the invention.

For example, while series of acts have been described with regard to FIG. 4, the order of the acts may be modified in other implementations. Further, non-dependent acts may be performed in parallel.

It should be emphasized that the term “comprises/comprising” when used in the this specification is taken to specify the presence of stated features, integers, steps or components but does not preclude the presence or addition of one or more other features, integers, steps, components or groups thereof.

It will be apparent that aspects, as described above, may be implemented in many different forms of software, firmware, and hardware. The actual software code or specialized control hardware used to implement aspects described herein is not limiting of the invention. Thus, the operation and behavior of the aspects were described without reference to the specific software code—it being understood that one would be able to design software and control hardware to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
detecting movement of a finger on a touch screen display of a device; and
vibrating the device to indicate proximity of the finger to one of a plurality of objects displayed on the touch screen display.

2. The method of claim 1, further comprising:
generating increasing vibrations when the finger approaches the one of the plurality of objects on the touch screen display; and
generating decreasing vibrations when the finger moves away from the one of the plurality of objects on the touch screen.

3. The method of claim 2, wherein generating increasing vibrations includes generating vibrations with increasing intensity and generating decreasing vibrations includes generating vibrations with decreasing intensity.

4. The method of claim 2, wherein generating increasing vibrations includes generating vibrations with increasing frequency and generating decreasing vibrations includes generating vibrations with decreasing frequency.

5. The method of claim 1, further comprising:
generating maximum vibration when the finger is on top of the one of the plurality of objects on the touch screen display or in a zone on top of one of the plurality of objections on the touch screen.

6. The method of claim 1, further comprising:
generating minimum vibration when the finger is equidistant or near equidistant from two adjacent objects.

7. The method of claim 6, wherein generating minimum vibration includes generating no vibration.

8. The method of claim 1, further comprising:
generating an audible signal that increases in volume or frequency when the finger approaches one of the plurality of objects on the touch screen display; and
generating an audible signal that decreases in volume or frequency when the finger moves away from the one of the plurality of objects on the touch screen display.

9. The method of claim 8, wherein the audible signal is at a maximum volume or frequency when the finger is on top of one of the plurality of objects or in a zone on top of one of the plurality of objects.

10. The method of claim 8, wherein the audible signal is at a minimum volume or frequency when the finger is equidistant or near equidistant from two adjacent objects.

11. The method of claim 1, further comprising:
generating an visual signal that increases in brightness or frequency when the finger approaches one of the plurality of objects on the touch screen display; and
generating an visual signal that decreases in brightness or frequency when the finger moves away from the one of the plurality of objects on the touch screen display.

12. The method of claim 11, wherein the visual signal is at a maximum brightness or frequency when the finger is on top of one of the plurality of objects or in a zone on top of one of the plurality of objects.

13. The method of claim 11, wherein the visual signal is at a minimum brightness or frequency when the finger is equidistant or near equidistant from two adjacent objects.

14. A device comprising:
a touch screen display;
a vibrator; and
processing logic configured to:
determine a location of a finger of a user on the touch screen display; and
cause the vibrator to generate vibrations to indicate proximity of the finger to one of a plurality of objects displayed on the touch screen display.

15. The device of claim 14, where in the processing logic is further configured to:
cause the vibrator to increase vibrations as the finger approaches the one of the plurality of objects; and
cause the vibrator to decrease vibrations as the finger moves away from the one of the plurality of objects.

16. The device of claim 14, wherein the processing logic is further configured to:
cause the vibrator to vibrate at a maximum level when the finger is on top of the one of the plurality of objects.

17. The device of claim 14, wherein the processing logic is further configured to:
cause the vibrator to vibrate at a minimum level when the finger is equidistant from two adjacent objects.

18. The device of claim 14, wherein the processing logic is further configured to:
cause the vibrator to increase the intensity of the vibrations as the finger approaches the one of the plurality of objects; and
cause the vibrator to decrease the intensity of the vibrations as the finger moves away from the one of the plurality of objects.

19. The device of claim 14, wherein the processing logic is further configured to:
cause the vibrator to increase the frequency of the vibrations as the finger approaches the one of the plurality of objects; and
cause the vibrator to decrease the frequency of the vibrations as the finger moves away from the one of the plurality of objects.

20. The device of claim 14, further comprising a speaker, wherein the speaker emits a signal when the finger is near the one of the plurality of objects.

21. The device of claim 20, wherein the signal increases in volume or frequency as the finger approaches the one of the plurality of objects and decreases in volume or frequency as the finger moves away from the one of the plurality of objects.

22. The mobile terminal of claim 20, wherein the signal is at maximum volume or frequency when the finger is on top of one of the plurality of objects or in a zone on top of one of the plurality of objects and the signal is at a minimum volume or frequency when the finger is equidistant or near equidistant from two adjacent objects.

23. A method comprising:
displaying a plurality of graphical objects on a touch screen display of a mobile communication terminal;
detecting a position of a finger on the touch screen display; and
generating a feedback response for a user of the mobile communication terminal based on the detected position of the finger.

24. The method of claim 23, wherein the graphical objects include one of number keys or letter keys.

25. The method of claim 23, wherein the feedback response includes vibration of the mobile communication terminal.
